(19) United States
(12) Patent Application Publication
(10) Pub. No.: US 2010/0312632 A1
(43) Pub. Date: Dec. 9, 2010

(54) COUPON CARD GENERATION WEB SERVICE

(76) Inventor: Karen L. Cervenka, Belmont, CA (US)

Correspondence Address: Quarles & Brady LLP, TWO NORTH CENTRAL AVENUE, One Renaissance Square, PHOENIX, AZ, 85004-2391, US

(21) Appl. No.: 12/480,268

(22) Filed: Jun. 8, 2009

(51) Int. Cl. G06Q 30/00

(52) U.S. Cl. 705/14.38; 705/14.39

(57) ABSTRACT

A method is presented where, at a web service, a selection of an electronic coupon from a database is received from a web browser. The electronic coupon is associated with the account of the electronic coupon sponsor and is receivable by a merchant for a discount which is debited from the sponsor's account and credited to the merchant's account. A specification is then received that includes the rendering capability of the client, a type of portable coupon device associated with a consumer account and acceptable as payment for a future purchase, and an identifier of the consumer account. Next, a rendering image, a location to store the discount information in the memory of the type of the portable coupon device, and the discount information is retrieved from the database. Finally, the web browser transmits, via the web service, the rendering image, memory location, and discount information.

### CROSS NOTING

The case is filed concurrently with U.S. Patent Application Ser. No. ______, by Karen Cervenka, titled Transaction Handler Merchant Reimbursement For Consumer Transaction Use Of Sponsor Discount Coupon Card, and with U.S. Patent Application Ser. No. ______, by Karen Cervenka, titled Dual Range Cellular Telephone Coupon Card Generation, and with U.S. Patent Application Ser. No. ______, by Karen Cervenka, titled Coupon Card Kiosk, and with U.S. Patent Application Ser. No. ______, by Karen Cervenka, titled Coupon Card Point Of Service Terminal Processing, each of which is incorporated herein by reference.

### FIELD

The present invention is related to a transaction between a merchant and a consumer, is more particularly related to a discount on such a transaction, and is most particularly related to a coupon being presented by the consumer to the merchant to obtain the discount on the transaction.

### BACKGROUND

Consumers obtain paper coupons in a variety of ways. They may cut them out of a newspaper or receive them at a Point of Service (POS) terminal when making a purchase. Sometimes paper coupons are mailed to consumers by the sponsor of the paper coupon or other entity. Each of these distribution methods, however, are associated with recurring costs. Every time a manufacturer or merchant decides to offer a paper coupon they must pay to have them printed and distributed.

Moreover, paper coupons are cumbersome and easily lost. Many consumers spend valuable time clipping the paper coupons they want from newspapers. Those who use a large number of paper coupons often spend additional time sorting the coupons into categories so that a particular coupon is easier to find. Further, customers will often receive the paper coupon some time before they intend to use it. The consumer must then store the paper coupon until they go shopping.

Additionally, consumers may not receive paper coupons for specific items they buy even though the coupons are available from a manufacturer or merchant. The consumer may not be on the mailing list to receive the coupon or it may not have been printed in the newspaper they buy. In some cases this may cause the consumer to forego purchasing a specific item in favor of a less costly alternative.

Thus, there is a need for a system that reduces the costs incurred by merchants and manufacturers in offering coupons as well as one that allows consumers to be able to quickly find and obtain the coupons they want.

### SUMMARY

In one implementation, a method is presented where, at a web service, a electronic coupon is selected from a database received from a web browser. The electronic coupon is associated with the account of the electronic coupon sponsor and is receivable by a merchant for a discount which is debited from the sponsor's account and credited to the merchant's account. A specification is then received that includes the rendering capability of the client, a type of portable coupon device associated with a consumer account and acceptable as payment for a future purchase, and an identifier of the consumer account. Next, a rendering image, a location to store the discount information in the memory of the type of the portable coupon device, and the discount information is retrieved from the database. Finally, the web browser transmits, via the web service, the rendering image, memory location, and discount information.

In another implementation an article of manufacture is presented comprising a computer readable medium comprising computer readable program code disposed therein. The computer readable program code comprises a series of computer readable program steps to effect receiving, at a web service, a selection of an electronic coupon from a database from a web browser. The electronic coupon is associated with the account of the electronic coupon sponsor and is receivable by a merchant for a discount which is debited from the sponsor's account and credited to the merchant's account. The computer readable program code further comprises a series of computer readable program steps to effect receiving a specification that includes the rendering capability of the client, a type of portable coupon device associated with a consumer account and acceptable as payment for a future purchase, and an identifier of the consumer account. The computer readable program code additionally comprises a series of computer readable program steps to effect retrieving from the database a rendering image, a location to store the discount information in the memory of the type of the portable coupon device, and the discount information, as well as transmitting, via the web service, the rendering image, memory location, and discount information.

In yet another implementation, an apparatus is presented that includes a web service, a database, and a means for transmitting to a web browser, via the web service, a rendering image, a memory location, and discount information. The web service is capable of receiving a selection from the web browser of an electronic coupon from the data base and a specification. The electronic coupon is associated with a sponsor account and is receivable by a merchant for a discount which is debited from the sponsor's account and credited to the merchant's account. The specification includes the rendering capability of the client, a type of portable coupon device associated with a consumer account and acceptable as payment for a future purchase, and an identifier of the consumer account. The database includes the rendering image, the memory location, and the discount information.

The foregoing and other objects and advantages of the inventions will appear in the detailed description that follows. In the description, reference is made to the accompanying drawings.

### BRIEF DESCRIPTION OF THE DRAWINGS

Implementations of the invention will become more apparent from the detailed description set forth below when taken in conjunction with the drawings, in which like elements bear like reference numerals.

FIG. 1 illustrates an exemplary payment processing network, depicting the general environment where a coupon card may be used by a card holder to obtain a discount on a purchase;

FIG. 2 depicts the environment within FIG. 1 where a consumer selects electronic coupons for storage on a coupon card and uses the coupon card to obtain a discount on a purchase;

FIG. 3 presents a flowchart of an exemplary method used by a personal computing system to provide a consumer with a coupon card having an electronic coupon stored thereon.

FIG. 4 illustrates possible alternative implementations of the data encoding area of a coupon card.

### DETAILED DESCRIPTION

The present discussion considers the distribution of electronic coupons to consumers via a personal computer system and their use for obtaining discounts on goods or services.

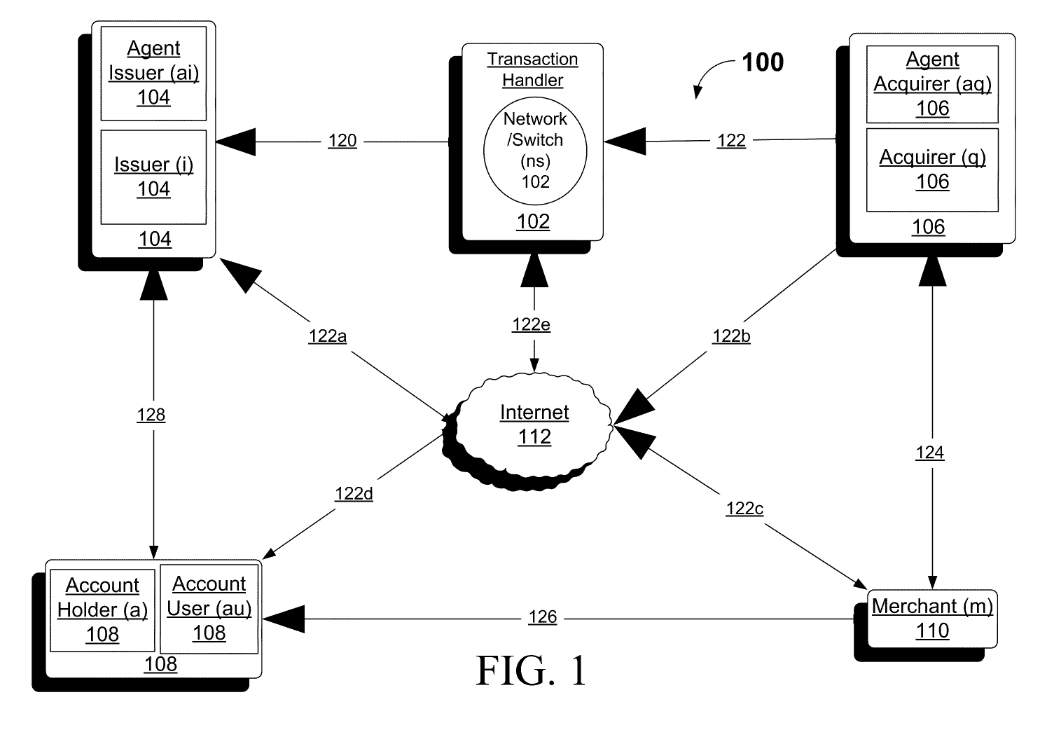

FIG. 1 illustrates an exemplary payment processing system 100, depicting a general environment in which a merchant (m) 110 can conduct a transaction for goods and/or services with an account user (au) on an account (i.e., a prepaid account) issued to an account holder (a) 108 by an issuer (i) 104, where the processes of paying and being paid for the transaction are coordinated by a transaction handler 102. The transaction includes participation from different entities that are each a component of the payment processing system 100.

Payment processing system 100 has a plurality of merchants 110 that includes merchant (1) 110 through merchant (M) 110, where M can be up to and greater than an eight digit integer.

Payment processing system 100 has a plurality of prepaid accounts 108 each of which is held by a corresponding account holder (1) 108 through account holder (A) 108, where A can be up to and greater than a ten eight digit integer.

Payment processing system 100 includes account user (1) 108 through account user (AU) 108, where AU can be as large as a ten digit integer or larger. Each account user (au) conducts a transaction for goods and/or services with merchant (m) 110 using an account (i.e., a prepaid account) that has been issued by an issuer (i) 104 to a corresponding account holder (a) 108. Data from the transaction on the account is collected by merchant (m) and forwarded to a corresponding acquirer (a) 106. Acquirer (a) 106 forwards the data to transaction handler 102 who facilitates payment for the transaction from the prepaid account issued by the issuer (i) 104 to account holder (a) 108.

Payment processing system 100 has a plurality of issuers 104. Each issuer (i) 104 may be assisted in processing one or more transactions by a corresponding agent issuer (ai) 104, where ‘i’ can be an integer from 1 to I, where ‘ai’ can be an integer from 1 to AI, and where I and AI can be as large as an eight digit integer or larger.

Payment processing system 100 has a plurality of acquirers 106. Each acquirer (q) 106 may be assisted in processing one or more transactions by a corresponding agent acquirer (aq) 104, where ‘q’ can be an integer from 1 to Q, where aq can be an integer from 1 to AQ, and where Q and AQ can be as large as a eight digit integer or larger.

Payment processing system 100 has a transaction handler 102 to process a plurality of transactions. The transaction handler 102 can include one or a plurality or networks and switches 102. Each network/switch (ns) 102 can be a mainframe computer in a geographic location different than each other network/switch (ns) 102, where ‘ns’ is an integer from one to NS, and where NS can be as large as a four digit integer or larger.

Dedicated communication systems 120, 122 (i.e., private communication network(s)) facilitate communication between the transaction handler 102 and each issuer (i) 104 and each acquirer (a) 106. The Internet 112, via e-mail, the World Wide Web, cellular telephony, and/or other optional public and private communications systems, can facilitate communications 122a-122e among and between each issuer (i) 104, each acquirer (a) 106, each merchant (m) 110, each account holder (a) 108, and the transaction handler 102. Alternatively and optionally, one or more dedicated communication systems 124, 126, and 128 can facilitate respective communications between each acquirer (a) 106 and each merchant (m) 110, each merchant (m) and each account holder (a) 108, and each account holder (a) 108 and each issuer (i) 104, respectively.

Each acquirer (q) 106 may be assisted in processing one or more transactions by a corresponding agent acquirer (aq) 104, where ‘a’ can be an integer from 1 to Q, where aq can be an integer from 1 to AQ, and where Q and AQ can be as large as a eight digit integer or larger.

Merchant (m) 110 may be a person or entity that sells goods and/or services. Merchant (m) 110 may also be, for instance, a manufacturer, a distributor, a retailer, a load agent, a drugstore, a grocery store, a gas station, a hardware store, a supermarket, a boutique, a restaurant, or a doctor's office. In a business-to-business setting, the account holder (a) 108 may be a second merchant making a purchase from another merchant (m) 110. Merchant (m) 110 may utilize at least one point-of-sale terminal (POS) that can communicate with acquirer (a) 106, transaction handler 102, or issuer (i) 104. Thus, the POS terminal is in operative communication with the payment processing system 100.

Typically, a transaction begins with account user (au) 108 presenting a portable consumer device to merchant (m) 110 to initiate an exchange for a good or service. The portable consumer device may be associated with an account (e.g., a prepaid account) of account holder (a) 108 that was issued to the account holder (a) 108 by issuer (i) 104.

The portable consumer device may be in a form factor that can be a payment card, a gift card, a smartcard, a smart media, a payroll card, a healthcare card, a wrist band, a machine readable medium containing account information, a keychain device, such as a SPEEDPASS® device commercially available from ExxonMobil Corporation, or a supermarket discount card, a cellular phone, personal digital assistant, a pager, a security card, an access card, a wireless terminal, or a transponder. The portable consumer device may include a volatile or non-volatile memory to store information such as the account number or an account holder (a) 108's name.

Merchant (m) 110 may use the POS terminal to obtain account information, such as a number of the account of the account holder (a) 108, from the portable consumer device. The portable consumer device may interface with the POS terminal using a mechanism including any suitable electrical, magnetic, or optical interfacing system such as a contactless system using radio frequency or magnetic field recognition system or contact system such as a magnetic stripe reader. The POS terminal sends a transaction authorization request to the issuer (i) 104 of the account corresponding to the portable consumer device. Alternatively, or in combination, the portable consumer device may communicate with issuer (i) 104, transaction handler 102, or acquirer (a) 106.

Issuer (i) 104 may authorize the transaction using transaction handler 102. Transaction handler 102 may also clear the transaction. Authorization includes issuer (i) 104, or transaction handler 102 on behalf of issuer (i) 104, authorizing the transaction in connection with issuer (i) 104's instructions such as through the use of business rules. The business rules could include instructions or guidelines from transaction handler 102, account holder (a) 108, merchant (km) 110, acquirer (a) 106, issuer (i) 104, a related financial institution, or combinations thereof. Transaction handler 102 may maintain a log or history of authorized transactions. Once approved, merchant (m) 110 will record the authorization, allowing account user (au) 108 to receive the good or service from merchant (m) or an agent thereof.

Merchant (m) 110 may, at discrete periods, such as the end of the day, submit a list of authorized transactions to acquirer (a) 106 or other transaction related data for processing through the payment processing system 100. Transaction handler 102 may compare the submitted authorized transaction list with its own log of authorized transactions. If a match is found, transaction handler 102 may route authorization transaction amount requests from the corresponding acquirer (a) 106 to the corresponding issuer (i) 104 involved in each transaction. Once acquirer (a) 106 receives the payment of the authorized transaction amount from issuer (i) 104, acquirer (a) 106 can forward the payment to merchant (m) 110 less any transaction costs, such as fees for the processing of the transaction. If the transaction involves a debit or pre-paid card, acquirer (a) 106 may choose not to wait for the issuer (i) 104 to forward the payment prior to paying merchant (m) 110.

There may be intermittent steps in the foregoing process, some of which may occur simultaneously. For example, acquirer (a) 106 can initiate the clearing and settling process, which can result in payment to acquirer (a) 106 for the amount of the transaction. Acquirer (a) 106 may request from transaction handler 102 that the transaction be cleared and settled. Clearing includes the exchange of financial information between the issuer (i) 104 and the acquirer (a) 106 and settlement includes the exchange of funds. Transaction handler 102 can provide services in connection with settlement of the transaction. The settlement of a transaction includes depositing an amount of the transaction settlement from a settlement house, such as a settlement bank, which transaction handler 102 typically chooses, into a clearinghouse, such as a clearing bank, that acquirer (a) 106 typically chooses. Issuer (i) 104 deposits the same from a clearinghouse, such as a clearing bank, which issuer (i) 104 typically chooses, into the settlement house. Thus, a typical transaction involves various entities to request, authorize, and fulfill processing the transaction.

Payment processing system 100 will preferably have network components suitable for scaling the number and data payload size of transactions that can be authorized, cleared and settled in both real time and batch processing. These include hardware, software, data elements, and storage network devices for the same. Examples of payment processing system 100 include those operated, at least in part, by American Express, Master Card, Discover Card, First Data Corporation, Diners Club, and Visa Inc., and agents of the foregoing.

Each network/switch (ns) 102 can include one or more data centers for processing transactions, where each transaction can include up to 100 kilobytes of data or more. The data corresponding to the transaction can include information about the types and quantities of goods and services in the transaction, information about the account holder (a) 108, the account user (au) 108, the merchant (m) 110, tax and incentive treatment(s) of the goods and services, coupons, rebates, rewards, loyalty, discounts, returns, exchanges, cash-back transactions, etc.

By way of example, network/switch (ns) 102 can include one or more mainframe computers (i.e., one or more IBM mainframe computers) for communications over systems 120, 122, one or more server farms (i.e., one or more Sun UNIX Superservers), where the mainframe computers and server farms can be in diverse geographic locations.

Each issuer (i) 104 (or agent issuer (ai) 104 thereof) and each acquirer (a) 106 (or agent acquirer (aq) 106 thereof) can use or more router/switch (i.e., Cisco routers/switches) to communicate with each network/switch (ns) 102 via dedicated communication systems 120, 122, respectively.

Transaction handler 102 stores information about transactions processed through payment processing system 100 in data warehouses such as may be incorporated as part of the plurality of networks/switches 102. This information can be data mined. The data mining transaction research and modeling can be used for advertising, account holder and merchant loyalty incentives and rewards, fraud detection and prediction, and to develop tools to demonstrate savings and efficiencies made possible by use of the payment processing system 100 over paying and being paid by cash, checks, or other traditional payment mechanisms.

The VisaNet® system is an example component of the transaction handler 102 in the payment processing system 100. Presently, the VisaNet® system is operated in part by Visa Inc. As of 2007, the VisaNet® system Inc. was processing around 300 million transaction daily, on over 1 billion accounts used in over 170 countries. Financial instructions numbering over 16,000 connected through the VisaNet® system to around 30 million merchants. In 2007, around 81 billion transactions for about 4 trillion U.S. dollars were cleared and settled through the VisaNet® system, some which involved a communication length of around 24,000 miles in around two (2) seconds.

In the present context, an account for the payment of future discounts on goods and services attributable to the use of electronic coupons is issued by the issuer to a third-party and credited with funds submitted by the third-party. The funds are for reimbursement of discounts on the sale of goods and services given by a merchant upon the presentation of a coupon card having at least one of the electronic coupons stored thereon.

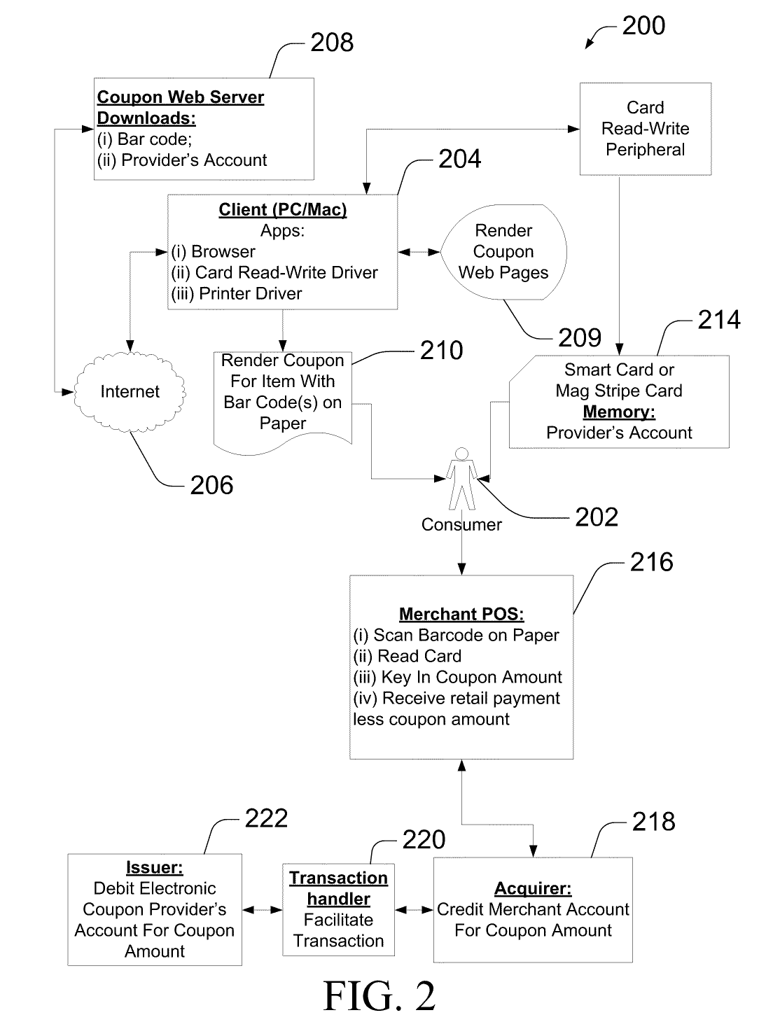

Within the general environment of the exemplary payment processing system depicted in FIG. 1, FIG. 2 illustrates the process by which consumer 202 selects an electronic coupon for storage on a coupon card and uses the coupon card to obtain a discount on a purchase. Consumer 202 uses the web browser of web-enabled computer system 204 to connect to Internet 206 and browse to website 208 where electronic coupons are available for download. In certain implementations, computer system 204 is a personal computer. In other implementations, computer system 204 is a laptop computer. In yet other implementations, computer system 204 is a tablet computer. In still other implementations, computer system 204 may be a blackberry or other hand held computing device.

In the illustrated implementation of FIG. 2, computer system 204 renders website 208 on associated display device 209. Website 208 displays the electronic coupons that are currently available. In certain implementations, website 208 is connected to a searchable database having multiple electronic coupons stored therein. Each of the electronic coupons are associated with the account of the sponsor of the electronic coupon and can be used by consumer 202 to receive a discount on a purchase.

In certain implementations, website 208 is a manufacturer's website having electronic coupons for products made by the manufacturer. In other implementations, website 208 is a merchant's website having electronic coupons for products sold by the merchant. In yet other implementations, website 208 is an unrelated party's website. In such an implementation, the unrelated party may be offering electronic coupons as part of a promotional effort, awareness campaign, or any other purpose. Alternatively, the unrelated party may offer a multitude of electronic coupons issued by different manufacturers and merchants for a fee. The fee may be paid by the sponsors of the electronic coupons in return for the service of offering their electronic coupons or the fee may be paid by consumer 202 as a membership fee for access to the electronic coupons.

Consumer 202, via the web browser, selects a coupon from website 208. In certain implementations, consumer 202 additionally provides information regarding computer system 204 such as, by way of example and not limitation, the capability of computer system 204 to render a hard copy of the electronic device, the type of coupon card consumer 202 has, and an identifier of an account issued to consumer 202. In certain implementations, the provided information further includes the capability of computer system 204 to communicate and write information to a portable coupon device. In certain implementations, website 208 retrieves such information from computer system 204.

When an electronic coupon is selected by consumer 202, information relating to that electronic coupon is retrieved and downloaded to computer system 204. In certain implementations, the information is retrieved from a database. The retrieved information, in certain implementations, includes identifiers for an account, the amount of the discount, and the item that is eligible for the discount. The retrieved information may also include a location in the memory of the portable coupon device where the identifiers are to be stored. The account identifier, as will be discussed in greater detail below, is associated with an account issued by an issuer to the third-party sponsor of the electronic coupon. The account is credited with funds provided by the coupon sponsor to pay for the discount applied when a consumer uses the electronic coupon.

In certain implementations, the retrieved information further includes the category or type of product or service for which the electronic coupon is valid. By way of example and not limitation, the electronic coupon may be valid for all cleaning products made by a particular manufacturer. Alternatively, the electronic coupon may be valid for a specific dish soap made by the manufacturer.

In certain implementations, the retrieved information includes a merchant or manufacturer with which the electronic coupon is valid. In such an implementation, the electronic coupon may be valid for use only with a particular merchant or only for purchase of a particular manufacturer's product. In other implementations, the retrieved information includes an expiration date, after which the electronic coupon is no longer valid. In yet other implementations, the retrieved information includes the number of goods or services eligible for a discount using the electronic coupon. By way of example and not limitation, the electronic coupon may be valid for discounts on up to three (3) bottles of a pain reliever. Alternatively, the electronic coupon may only be used when ten (10) car washes are purchased at the same time.

In certain implementations, the retrieved information also includes a bar code identifying the type of item for which the electronic coupon is valid. In such an implementation, the bar code is rendered on print-out 210 using a printer connected to computer system 204. In certain implementations, the bar code on print-out 210 is later scanned by a scanner at a POS terminal to identify the type of item eligible for a discount using the electronic coupon. Print-out 210 also serves as a reminder to consumer 202 of the electronic coupons they selected.

In certain implementations, the retrieved information further includes instructions executable by computer system 204. In such implementations, the instructions may be, by way of example and not limitation, to communicate information to a coupon card, communicate a command executable by a coupon card to store information in a particular location in memory, or to render print-out 210 of the electronic coupon.

In certain implementations, print-out 210 additionally includes advertisements. In certain implementations, print-out 210 includes information regarding soon-to-be-available electronic coupons.

In certain implementations, the bar codes are printed on print-out 210 in an order that makes it easier for consumer 202 to find the specific electronic coupon they wish to use. In such implementations, the ordering may by the item type. Alternatively, the ordering may be alphanumeric, by manufacturer, by merchant, or by any other means of ordering, or a combination thereof. Further, in certain implementations, consumer 202 selects the ordering used. In yet other implementations, consumer 202 selects the specific electronic coupons they intend to use and have only those bar codes printed on print-out 210. By way of example and not limitation, a consumer who is going grocery shopping is able to print only the bar codes for the electronic coupons valid at that grocery store even though they additionally downloaded electronic coupons for a hardware store.

In the illustrated implementation of FIG. 2, the information is written to a coupon card using card read-write device 212. In certain implementations, card read-write device 212 is attached as a peripheral to computer system 204. In certain implementations, card read-write device 212 is a memory card reader. In such an implementation, the coupon card is a smart card and the information is stored in the memory of an embedded chip. In certain implementations, the coupon card is a contact smart card having a contact area that when inserted into card read-write device 212 makes contact with electrical connectors capable of writing the information to memory. In certain implementations, the coupon card is a contactless smart card in which the chip communicates with card read-write device 212 through radio-frequency identification (RFID) induction technology.

In certain implementations, card read-write device 212 is a magnetic card reader. In such an implementation, the coupon card has a magnetic data stripe. The information is stored on the coupon card when the magnetic data stripe is placed in physical contact with a read-write head of card read-write device 212.

In certain implementations, the coupon card includes both an embedded chip and a magnetic stripe. In certain implementations, the coupon card is also a portable consumer device, such as a credit card, debit card, prepaid card, loyalty card, or other such device associated with an account of consumer 202. In such implementations, consumer 202 may use the coupon card to both receive a discount on an item and to pay for the purchase price of the item.

Consumer 202 may obtain the coupon card by purchasing it from a merchant. Alternatively, consumer 202 may receive the coupon card for free. By way of example, and not by way of limitation, the coupon card may be provided by a grocery store as a promotional item and may only be used for discounts on items purchased at the grocery store. Where the coupon card is also a portable consumer device, consumer 202 may receive the coupon card from an issuer.

After information pertaining to the electronic coupon is stored on the coupon card, the coupon card can be used in a future transaction with merchant 216 for a discount on an item. In certain implementations, when purchasing an item, consumer 202 presents the coupon card at the POS terminal of merchant 216 and the information stored thereon is read to determine the associated account. In certain implementations, the coupon card is read by swiping the coupon card through the POS terminal. In other implementations, the POS terminal reads the coupon card using RFID when consumer 202 is near the POS terminal. In yet other implementations, to be read, the coupon card is inserted into the POS terminal such that external contacts on the coupon card establish connectivity with the POS terminal.

In certain implementations, other information is read, such as, by way of example and without limitation, an expiration date, an item type, or an item quantity. In such implementations, the POS terminal may determine whether the electronic coupon is valid for the item being purchased. This may occur, by way of example and not limitation, by comparing the current date with the expiration data of the coupon. Alternatively, the POS terminal may determine whether consumer 202 has purchased the quantity of the discounted item specified. The POS terminal may also verify whether consumer 202 has purchased the item type for which the electronic coupon is applicable.

In certain implementations, consumer 202 additionally presents print-out 210. In such an implementation, the bar code printed on print-out 210 is scanned with a scanner of the POS terminal to identify the item that is eligible for the discount. In certain implementations, the merchant 216 additionally enters the amount of the discount into the POS terminal.

In the illustrated implementation of FIG. 2, Merchant 216 submits the electronic coupon to payment processing system 100 (FIG. 1) for authorization in a similar manner to that described in connection with FIG. 1. Specifically, merchant 216 submits a request, including the account identifier of the sponsor of the electronic coupon to acquirer 218 for authorization. Where acquirer 218 is not the same entity as issuer 222, acquirer 218 forwards the request to transaction handler 220. Transaction handler 220 in turn requests that issuer 222 verify that the account associated with the sponsor of the electronic coupon contains sufficient funds to reimburse merchant 216 for the discount. Upon receipt of a reply from issuer 222, transaction handler 220 forwards an authorization response to acquirer 218, who forwards it to merchant 216. Where the authorization response contains an approval of the electronic coupon, consumer 202 is given a discount on the retail purchase price of the item. In certain implementations, merchant 216 additionally invalidates or deletes the electronic coupon stored on the coupon card.

When merchant 216 submits the transaction to payment processing system 100 (FIG. 1) for clearing and settlement, the account of the coupon sponsor is debited for the cost of the discount. Specifically, merchant 216 submits a request for payment to acquirer 218. Where acquirer 218 is not the same entity as issuer 222, acquirer 218 forwards the request to transaction handler 220. Transaction handler 220 in turn requests payment for the discount from issuer 222, where issuer 222 is the issuer of the account associated with the coupon sponsor. Issuer 222 debits the account and forwards the payment to transaction handler 220 who forwards the payment to acquirer 218. Finally, acquirer 218 credits the account of merchant 216 account with the amount of the discount.

The steps of a method, process, or algorithm described in connection with the implementations disclosed herein may be embodied directly in hardware, in a software module executed by a processor, or in a combination of the two. In certain implementations, instructions are encoded in computer readable medium wherein those instructions are executed by a processor to perform one or more of the steps recited in describing FIG. 2.

In yet other implementations, the invention includes instructions residing in any other computer program product, where those instructions are executed by a computer external to, or internal to, a computing system to perform one or more of the steps recited in describing FIG. 2. In either case the instructions may be encoded in a computer readable medium comprising, for example, a magnetic information storage medium, an optical information storage medium, an electronic information storage medium, and the like. “Electronic storage media,” may mean, for example and without limitation, one or more devices, such as and without limitation, a PROM, EPROM, EEPROM, Flash PROM, compactflash, smartmedia, and the like.

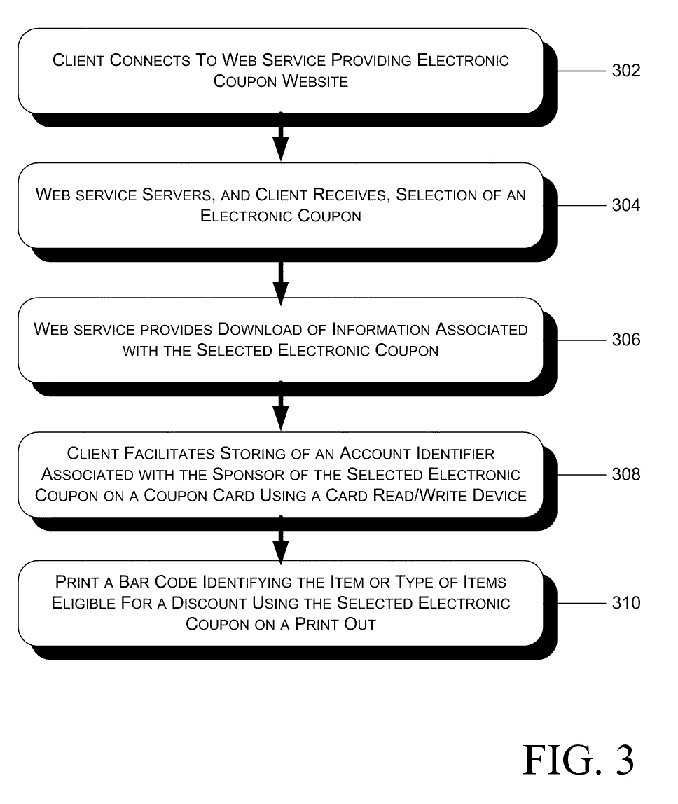

Turning now to FIG. 3, a flow chart of an exemplary method used by a personal computing system to provide a consumer with a coupon card having an electronic coupon stored thereon is presented. As indicated by block 302, the personal computer system connects to a website having a web service to serve electronic coupons for download via the internet. Upon receipt of a selection of an electronic coupon, information associated with the electronic coupon is downloaded to the personal computer system, including an account identifier associated with the sponsor of the selected electronic coupon and a bar code identifying the item or type of item eligible for a discount using the selected electronic coupon, as indicated by blocks 304 and 306. In certain implementations, additional information associated with the selected electronic coupon is also downloaded, such as, by way of example and not limitation, an expiration date, the item type, a quantity, the discount amount, or any other information regarding the electronic coupon, or combination thereof.

Next, the account identifier is stored on a coupon card via a card read/write device, where the card read/write device is part of the personal computer system, as indicated by block 308. In certain implementations, additional information associated with the selected electronic coupon is stored on the coupon card. Lastly, as indicated by block 310, the personal computer system prints the downloaded bar code on a print-out, where the bar code can be scanned by a scanner of a POS terminal.

In certain implementations, individual blocks described above may be combined, eliminated, or reordered.

In certain implementations, instructions are encoded in computer readable medium wherein those instructions are executed by a processor to perform one or more of the blocks 302, 304, 306, 308, 310, 312, and 314 recited in FIG. 3.

In yet other implementations, the invention includes instructions residing in any other computer program product, where those instructions are executed by a computer external to, or internal to, a computing system to perform one or more of the blocks 302, 304, 306, 308, 310, 312, and 314 recited in FIG. 3. In either case the instructions may be encoded in a computer readable medium comprising, for example, a magnetic information storage medium, an optical information storage medium, an electronic information storage medium, and the like. “Electronic storage media,” may mean, for example and without limitation, one or more devices, such as and without limitation, a PROM, EPROM, EEPROM, Flash PROM, compactflash, smartmedia, and the like.

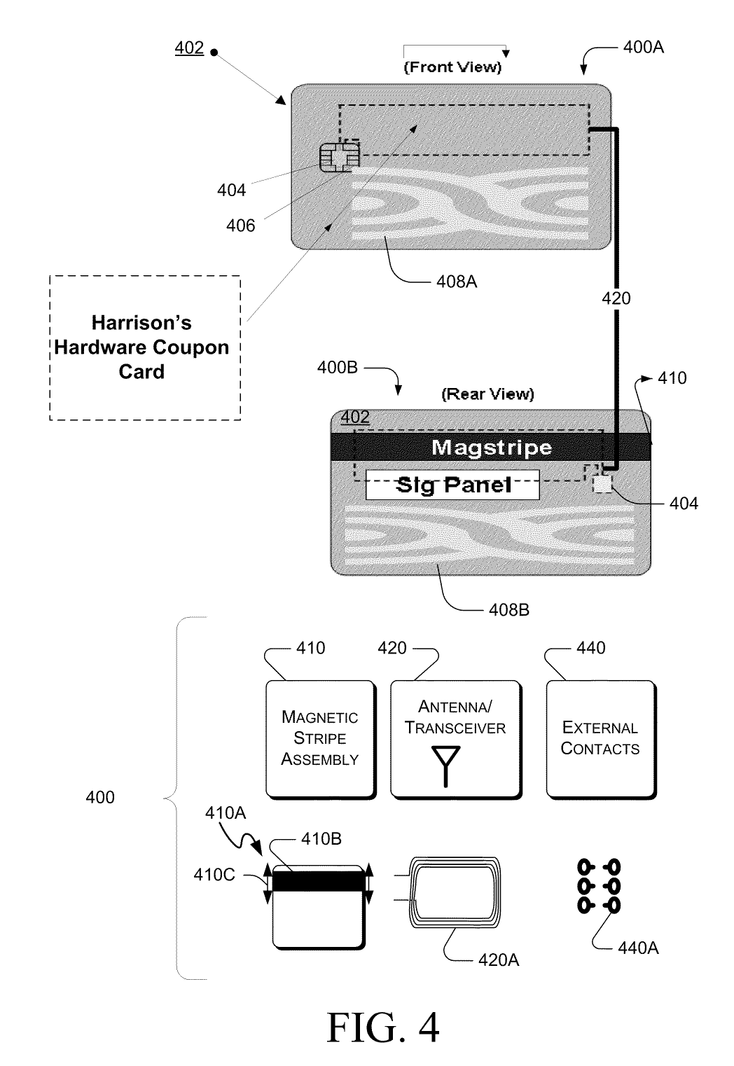

Turning to FIG. 4 both a front view 400A and a rear view 400B of a coupon card 402 are presented. Images may be displayed on both sides of coupon card 402, with image 408A on the front view 400A being either the same as or different from image 408B on the rear view 400B. In this illustration, the front view 400B also displays information about the provider of the coupon card.

FIG. 4 also shows exemplary implementations of a data encoding area of coupon card 402. The data encoding area may include an optional shielding element, which allows desired electromagnetic, optical, or radiative signals to penetrate while protecting the data encoding area from physical abuse or damage. Coupon card 402 may optionally have areas outside of the data encoding area shielded from physical abuse or otherwise acceptable forms of electromagnetic radiation. Some of the acceptable signals that are allowed to penetrate the shielding and may include, but are not limited to, signals accompanying a magnetic field, RFID signals, IrDA signals, visible light, invisible light, modulated laser, and/or modulated RF communication signals. By way of example and not by way of limitation, a selective shielding element may comprise a clear plastic shield, conformal coatings, an opaque plastic shield, or a clear thin film, depending on the implementation of the data encoding area.

Non-limiting examples of the data encoding area are shown at reference numeral 400, and include a magnetic stripe assembly 410, an antenna and/or transceiver 420, and electrical contacts 440. Magnetic stripe assembly 410 may comprise, in one implementation 410A, a reprogrammable magnetic stripe 410B that accepts data and/or commands from a processor and formats and renders that data into a form on a magnetic stripe that is readable by conventional merchant magnetic stripe-reading point of service (POS) terminals. In this manner, the processor may program a particular account for use in a transaction as a function of user input selecting the account. Alternatively, the processor may erase the magnetic stripe of assembly 410, rendering the card useless in the event of its loss or theft. In one implementation shown, 410A, magnetic stripe assembly 410B at least partially slidably, moves 410C into and out of an assembly of coupon card 402 (partial view shown), allowing coupon card 402 to conduct a transaction at a point of service terminal that includes a magnetic stripe reader.

Continuing with FIG. 4, another implementation of the data encoding area is shown as an antenna and/or transceiver 420. Antenna and/or transceiver 420 may include commonly used loop inductors such as the one shown, 420A, or in those shown in related ISO standards for RF-readable smart cards. With such an interface, account data may be translated, modulated and transmitted in a manner acceptable by an RF contactless merchant POS terminal, an 802.11 WiFi or WiMax network, or by a cellular or RF communications network.

Electrical contacts 440 are yet another alternative implementation of the data encoding area shown in FIG. 4. With coupon card 402 possessing physical contacts such as an array of conductive pads or shapes 440A, the transaction token may be placed in physical contact with a merchant POS terminal, and electrical contacts 440 may establish connectivity to the merchant's financial processing system. The processor may relay account-related information to the merchant POS terminal through the contact interface, thereby allowing coupon card 402 to be utilized with the large number of preexisting merchant POS terminals.

As an example of how the described coupon card may be obtained and used, a consumer having a coupon card may be considering going grocery shopping. Prior to leaving, the consumer uses their PC to access a website providing electronic coupons from a multitude of merchants and manufacturers. The consumer selects the electronic coupons they want; for example, one for bread offered by the manufacturer of the bread, and one for pet food offered by the grocery store the consumer is going to. The electronic coupons and associated information is then downloaded to the consumer's PC from a web service. The consumer inserts their coupon card into a card read-write device in communication with their PC. Then, the card read-write device writes the account identifiers for the account associated with the manufacturer of the bread and the account associated with the grocery store to the magnetic stripe of the electronic card and/or the card's electronic memory. The consumer then uses a printer attached to their PC to print a print-out of the electronic coupons they downloaded, including bar codes identifying the items to which the discount will be applied.

The consumer takes the coupon card and the print-out with them to the grocery store. At the check-out counter, the consumer provides the coupon card and a print-out of bar codes to the cashier. The cashier swipes the magnetic strip of the coupon card through the POS terminal and scans the bar codes on the print-out. The cashier then scans the SKU/UPCs for each item the consumer is purchasing. The POS terminal determines if the electronic coupons apply to any of the items by comparing the bar codes with the scanned SKU/UPCs. For example, the coupon card may contain multiple electronic coupons, one of which is for a discount on bread and is provided by the manufacturer of the bread. Another electronic coupon, that is provided by the grocery store, may be for a discount on pet food. When the POS terminal receives the SKU/UPCs for a loaf of bread and a bag of pet food, the POS terminal requests authorization to apply a discount to the items. The authorization request is, for example, received by the grocery store's acquirer.

As the acquirer is the issuer of the account associated with the grocery store (i.e., the merchant), the acquirer verifies if the account has been credited with sufficient funds to pay for the discount on the pet food and sends an authorization response to the POS terminal. The request for authorization to apply a discount to the bread is forwarded by the acquirer to a transaction handler for processing. The transaction handler in turn may forward a request to the issuer of the manufacturer's account for verification that the account contains sufficient funds. Upon receiving a response, the transaction handler may send an authorization response authorizing the application of the discount to the bread.

Once the POS terminal receives the authorization responses for both coupons, the discounts are applied. The consumer may then use the coupon card to pay for the items, where the coupon card is associated with an account of the consumer's (i.e., the consumer's debit or credit card is also the coupon card), or the consumer may use an alternative payment method.

The steps, methods, processes, and devices described in connection with the implementations disclosed herein, are made with reference to the Figures, in which like numerals represent the same or similar elements. While described in terms of the best mode, it will be appreciated by those skilled in the art that the description is intended to cover alternatives, modifications, and equivalents as may be included within the spirit and scope of the invention as defined by the appended claims and their equivalents as supported by the following disclosure and drawings. Reference throughout this specification to “one implementation,” “an implementation,” or similar language means that a particular feature, structure, or characteristic described in connection with the implementation is included in at least one implementation of the present invention. Thus, appearances of the phrases “in one implementation,” “in an implementation,” and similar language throughout this specification may, but do not necessarily, all refer to the same implementation.

The described features, structures, or characteristics of the invention may be combined in any suitable manner in one or more implementations. In the above description, numerous specific details are recited to provide a thorough understanding of implementations of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow charts included are generally set forth as logical flow chart diagrams. As such, the depicted order and labeled steps are indicative of one implementation of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the methods. Although various arrow types and line types may be employed in the flow chart diagrams, they are understood not to limit the scope of the corresponding method. Indeed, some arrows or other connectors may be used to indicate only the logical flow of the methods. For instance, an arrow may indicate a waiting or monitoring period of unspecified duration between enumerated steps of the depicted methods. Additionally, the order in which a particular method occurs may or may not strictly adhere to the order of the corresponding steps shown.

The present invention may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
receiving at a web service:
a selection from a web browser of at least one electronic coupon from a database having a plurality of said electronic coupons each:
being associated with a sponsor account issued to a sponsor of a discount by an issuer; and
for being receivable by a merchant to give the discount on a purchase, wherein the discount is to be debited from the sponsor account and credited to a merchant account issued by another said issuer to the merchant to reimburse the merchant for the discount;
and
a specification including:
a rendering capability of a client executing the web browser for rendering a hard copy of the at least one said electronic coupon using a first peripheral device with which the client is in communication;
a type of a portable coupon device, associated with a consumer account issued by another said issuer, and acceptable as payment for a future said purchase to be made on the consumer account;
and
an identifier for the consumer account to be debited for the payment for the future said purchase less the discount;
retrieving, from the database:
a rendering image corresponding to the rendering capabilities of the first peripheral device for the hard copy;
a memory location to store discount information in a memory of the type of the portable coupon device; and
the discount information including an identifier for:
the sponsor account;
the discount amount; and
the purchase that is eligible for the discount from the merchant and including at least one of a good and a service;
and
transmitting to the web browser, via the web service, the rendering image, the memory location, and the discount information.

2. The method of claim 1, further comprising receiving at the web service a communication capability of the client executing the web browser for communicating the discount information to the portable coupon device using a second peripheral device with which the client is in communication.

3. The method of claim 2, further comprising transmitting to the web browser, via the web service, a first instruction to communicate the discount information to the portable coupon device using the second peripheral device.

4. The method of claim 1, further comprising transmitting to the web browser, via the web service, a second instruction to communicate a command, executable by the portable coupon device, to store the discount information in the memory location.

5. The method of claim 1, further comprising transmitting to the web browser, via the web service, a third instruction to render the hard copy of the at least one electronic coupon using the first peripheral device.

6. The method of claim 1, wherein the rendering image includes a barcode identifying the purchase, wherein the barcode is capable of being scanned by a scanner.

7. The method of claim 1, wherein the sponsor account is issued to a member of the group comprising:
the merchant selling the purchase;
a manufacturer of the purchase;
a wholesaler of the purchase; and
a distributer of the purchase.

8. An article of manufacture comprising a computer readable medium comprising computer readable program code disposed therein, the computer readable program code comprising a series of computer readable program steps to effect:
receiving at a web service:
a selection from a web browser of at least one electronic coupon from a database having a plurality of said electronic coupons each:
being associated with a sponsor account issued to a sponsor of a discount by an issuer; and
for being receivable by a merchant to give the discount on a purchase, wherein the discount is to be debited from the sponsor account and credited to a merchant account issued by another said issuer to the merchant to reimburse the merchant for the discount;
and
a specification including:
a rendering capability of a client executing the web browser for rendering a hard copy of the at least one said electronic coupon using a first peripheral device with which the client is in communication;
a type of a portable coupon device, associated with a consumer account issued by another said issuer, and acceptable as payment for a future said purchase to be made on the consumer account;
and
an identifier for the consumer account to be debited for the payment for the future said purchase less the discount;
retrieving, from the database:
a rendering image corresponding to the rendering capabilities of the first peripheral device for the hard copy;
a memory location to store discount information in a memory of the type of the portable coupon device; and
the discount information including an identifier for:
the sponsor account;
the discount amount; and
the purchase that is eligible for the discount from the merchant and including at least one of a good and a service;
and
transmitting to the web browser, via the web service, the rendering image, the memory location, and the discount information.

9. The article of manufacture of claim 8, further comprising computer readable program code comprising a series of computer readable program steps to effect receiving at the web service a communication capability of the client executing the web browser for communicating the discount information to the portable coupon device using a second peripheral device with which the client is in communication.

10. The article of manufacture of claim 9, further comprising computer readable program code comprising a series of computer readable program steps to effect transmitting to the web browser, via the web service, a first instruction to communicate the discount information to the portable coupon device using the second peripheral device.

11. The article of manufacture of claim 8, further comprising computer readable program code comprising a series of computer readable program steps to effect transmitting to the web browser, via the web service, a second instruction to communicate a command, executable by the portable coupon device, to store the discount information in the memory location.

12. The article of manufacture of claim 8, further comprising computer readable program code comprising a series of computer readable program steps to effect transmitting to the web browser, via the web service, a third instruction to render the hard copy of the at least one electronic coupon using the first peripheral device.

13. The article of manufacture of claim 8, wherein the rendering image includes a barcode identifying the purchase, wherein the barcode is capable of being scanned by a scanner.

14. The article of manufacture of claim 8, wherein the sponsor account is issued to a member of the group comprising:
the merchant selling the purchase;
a manufacturer of the purchase;
a wholesaler of the purchase; and
a distributer of the purchase.

15. An apparatus comprising:
a web service capable of receiving:
a selection from a web browser of at least one electronic coupon from a database having a plurality of said electronic coupons each:
being associated with a sponsor account issued to a sponsor of a discount by an issuer; and
for being receivable by a merchant to give the discount on a purchase, wherein the discount is to be debited from the sponsor account and credited to a merchant account issued by another said issuer to the merchant to reimburse the merchant for the discount;
and
a specification including:
a rendering capability of a client executing the web browser for rendering a hard copy of the at least one said electronic coupon on using a first peripheral device with which the client is in communication;
a type of a portable coupon device, associated with a consumer account issued by another said issuer, and acceptable as payment for a future said purchase to be made on the consumer account;
and
an identifier for the consumer account to be debited for the payment for the future said purchase less the discount;
the database having stored therein:
a rendering image corresponding to the rendering capabilities of the first peripheral device for the hard copy;
a memory location to store discount information in a memory of the type of the portable coupon device; and
the discount information including an identifier for:
the sponsor account;
the discount amount; and
the purchase that is eligible for the discount from the merchant and including at least one of a good and a service;
and
a means for transmitting to the web browser, via the web service, the rendering image, the memory location, and the discount information.

16. The apparatus of claim 15, wherein the web service is further capable of receiving a communication capability of the client executing the web browser for communicating the discount information to the portable coupon device using a second peripheral device with which the client is in communication.

17. The apparatus of claim 15, wherein the means for transmitting is capable of transmitting to the web browser, via the web service, a first instruction to communicate the discount information to the portable coupon device using the second peripheral device.

18. The apparatus of claim 17, wherein the means for transmitting is capable of transmitting to the web browser, via the web service, a second instruction to communicate a command, executable by the portable coupon device, to store the discount information in the memory location.

19. The apparatus of claim 18, wherein the means for transmitting is capable of transmitting to the web browser, via the web service, a third instruction to render the hard copy of the at least one electronic coupon using the first peripheral device.

20. The apparatus of claim 15, wherein the rendering image includes a barcode identifying the purchase, wherein the barcode is capable of being scanned by a scanner.

21. The apparatus of claim 15, wherein the discount information further includes an identification of the merchant, wherein the discount is valid when the purchase is from the merchant.
